(19) United States
(12) Patent Application Publication
(10) Pub. No.: US 2002/0183664 A1
(43) Pub. Date: Dec. 5, 2002

(54) Tilt type jin-luo massaging device

(76) Inventors: Shun-Tsung Lu, Taichung (TW); Ta-Wei Lu, Brea, CA (US)

Correspondence Address: David and Raymond Patent Group, 1050 Oakdale Lane, Arcadia, CA, 91006, US

(21) Appl. No.: 09/873,149

(22) Filed: Jun. 4, 2001

(51) Int. Cl. A61H 1/00

(52) U.S. Cl. 601/46

(57) ABSTRACT

A tilt type jin-luo massaging device is disclosed. Thereby, the user can stand thereon with the foot points higher than the heels. The tilt type jin-luo massaging device comprises a seat having a distal end bending upwards so as to be formed with a rear stopper; a pedal at an upper side of the seat and having a pivotal end pivotally connected to the seat near the rear stopper; the pedal further having a free end pivotally rotated with respect to the seat; and a supporting frame for elevating the free end of the pedal so that the pedal is positioned and therefore, the free ends are higher than a tilt position of the pivotal end.

### BACKGROUND OF THE INVENTION

1. Field of the Invention

The present invention relates to a tilt type jin-luo massaging device. Thereby, the user can stand thereon with the foot points higher than the heels.

2. Description of the Prior Art

In Chinese medicine, the so called ‘Jin-luo’ is a main and collateral channels, regarding as a network passage, through which energy circulates and along which the acupuncture points are distributed. A well energy circulation in the Jin-luo is beneficial to the human health.

Currently, due to busy life, people often feel ache due to an improper pose to be retained for a long period, such as traveling, sitting in the office, driving, running computer, etc., for a long period of time. Therefore, the circulation systems will feel uneasy even other diseases will be induced. However, these diseases can be avoided in advance as people can properly exercise their jin-luo so as to prompt the circulation of blood. Therefore, there is an eager demand for a novel jin-luo massaging device which may improve the health of human. However, the current commercial body exercising devices have large volumes and are heavy. In general, they are fixed at one place and can not be portable so as to confine the applications. Furthermore, the conventional body exercising devices often have a single function and have no function of prompting the activity of the jin-luo. Therefore, they are not suitable for all the people.

### SUMMARY OF THE INVENTION

Accordingly, the primary object of the present invention is to provide a tilt type jin-luo massaging device, wherein a user can stand on the tilt type jin-luo massaging device with the foot points higher than the heel and the rear ankles of the user resists against the stopper so that the calf stands still. The feet of the user will feel the muscle to be pulled. Therefore, the device has the function of prompting the circulation of blood and enforcing the backbone to be straight. Meanwhile, by the adjusting the tilting of the sole, the kidney and pelvis are active.

Another object of the present invention is to provide a tilt type jin-luo massaging device, wherein the present invention provides a vibrating massaging effect to the ankle of the user so as to prompt the circulation of blood and reduce the ache of the foot form exercising.

A further object of the present invention is to provide a tilt type jin-luo massaging device, wherein the tilt type jin-luo massaging device of the present invention has a simple structure and a compact volume and weight. The present invention only occupies a smaller space so that it can be stored in a smaller space and is portable without being confined as it is carried out.

To achieve the aforesaid object, the present invention provides a tilt type jin-luo massaging device. Thereby, the user can stand thereon with the foot points higher than the heels. The tilt type jin-luo massaging device comprises a seat having a distal end bending upwards so as to be formed with a rear stopper; a pedal at an upper side of the seat and having a pivotal end pivotally connected to the seat near the rear stopper; the pedal further having a free end pivotally rotated with respect to the seat; and a supporting frame for elevating the free end of the pedal so that the pedal is positioned and therefore, the free end is higher than a tilt position of the pivotal end.

### BRIEF DESCRIPTION OF THE DRAWINGS

The drawings disclose an illustrative embodiment of the present invention which serves to exemplify the various advantages and objects hereof, and are as follows:

FIG. 1 is a perspective view of the tilt type jin-luo massaging device according to the present invention.

FIG. 2 is an exploded perspective view of the tilt type jin-luo massaging device in the present invention.

FIG. 3 is a lateral view showing the application of the tilt type jin-luo massaging device in the present invention.

FIGS. 4 to 6 are lateral partial cross sectional views showing the pedal of the tilt type jin-luo massaging device of the present invention in different tilt angle.

FIG. 7 is a lateral partial cross sectional views showing the pedal of the tilt type jin-luo massaging device of the present invention in a storing condition.

FIG. 8 is a lateral cross sectional view of another embodiment of the tilt type jin-luo massaging device according to the present invention.

### DETAILED DESCRIPTION OF THE PREFERRED EMBODIMENTS

In Chinese medicine, the so called Jin-luo is a main and collateral channels, regarding as a network passage, through which energy circulates and along which the acupuncture points are distributed.

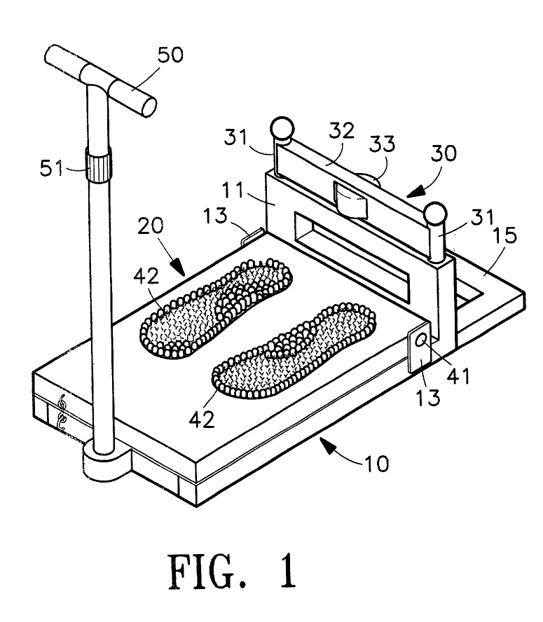

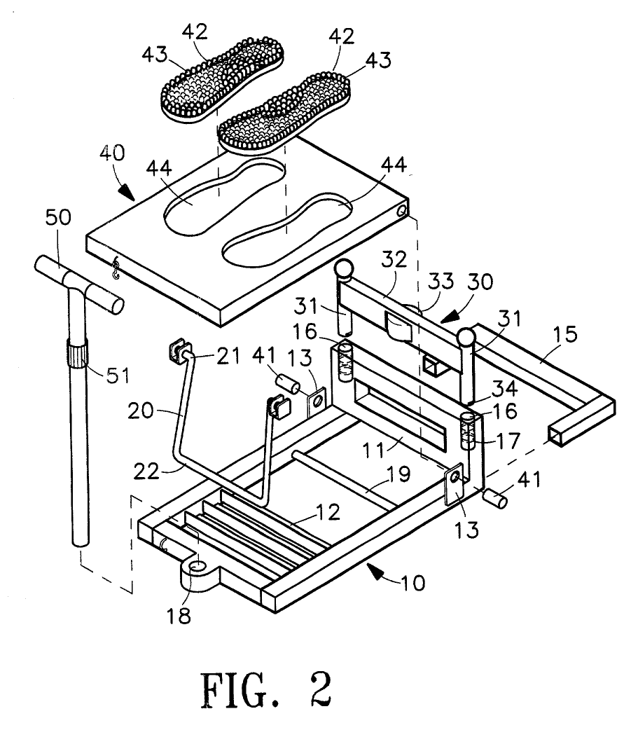

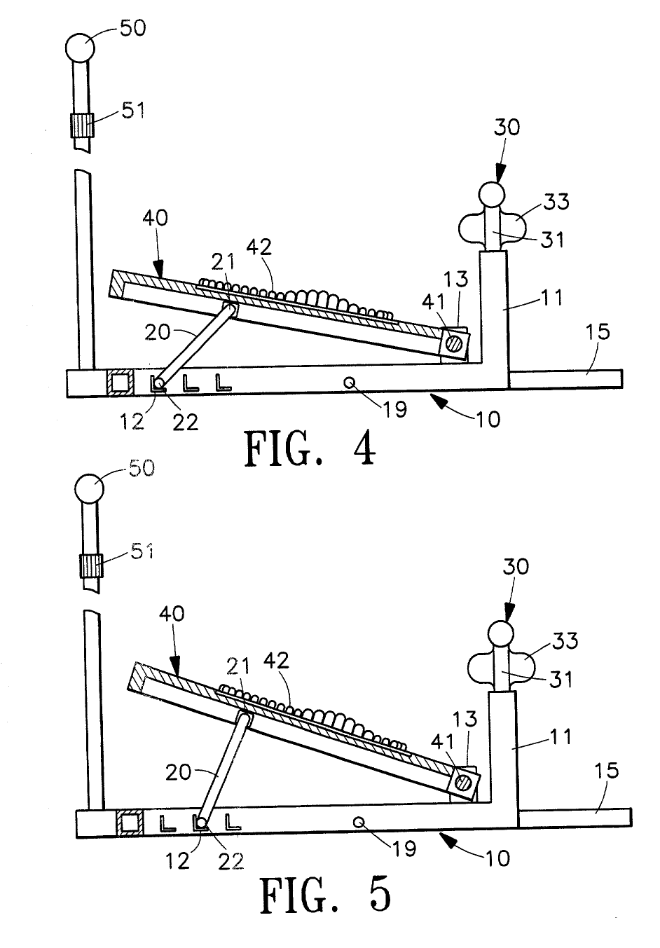

Referring to FIGS. 1 and 2, the tilt type jin-luo massaging device of the present invention is illustrated. The tilt type jin-luo massaging device according to the present invention includes a seat 10. A distal end of the seat 10 is bent vertically and upwards to be formed as a rear stopper 11. Two sides of the seat 10 near the stopper 11 are extended with a pair of pivotal ears 13. The pivotal ears 13 serve to be pivotally connected to pedals 40 above the seat 10. The pivotal ends 44 of the pedals 40 are pivotally connected to the pair of the pivotal ears 13 by the pins 41 at two sides so that the free end 45 of the pedal 40 may be pivotally rotated to be near or away from the seat 10. At a front end of the side of the pedal 40 near the pivotal ear 13 is pivotally installed with a supporting frame 20 having an approximate inverse U shape. The opening ends at the two lateral sides thereof extends toward and is inserted into the pedal 40 so that the supporting frame 20 may freely rotate with respect to the pedal 40. Near a front end of the seat 10 is installed with a plurality of parallel positioning portion 12. A free end 22 of the supporting frame 20 is installed with a plurality of positioning portions 12. The position portion 12 is selectable to be inserted into any positioning portion 12. Furthermore, the tilt supporting frame 20 serve to elevate the pedal 40 so that the front side thereof is higher than the rear side. And thus, the pedals 40 are positioned tilt at a selected angle as shown in FIGS. 4 to 6.

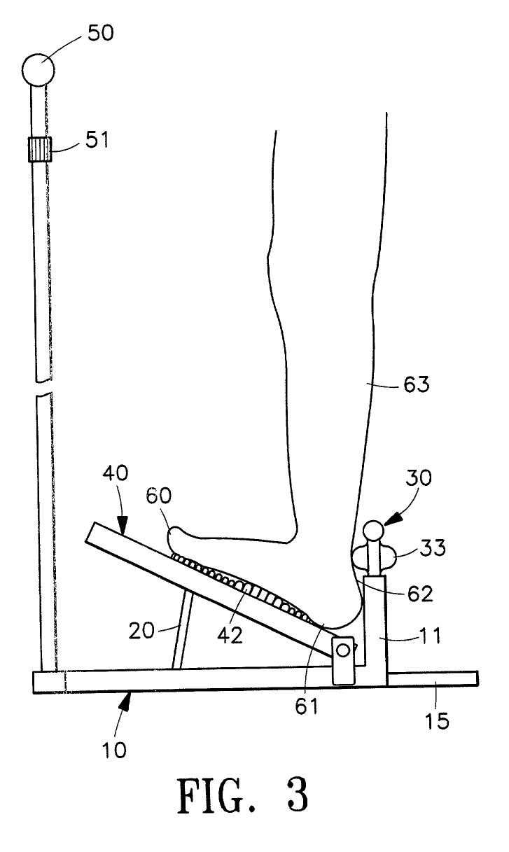

With reference to FIG. 3, the user stands on the tilt pedals 40 with a foot points higher than the heels, while the stoppers 11 serves to stop the rear foot ankle so as to prevent from sliding out of the pedals 40. Furthermore, the calf of the user retains straightly. Since the sole of the user is tilt abnormally, the feet of the user will feel the muscle to be pulled. Therefore, the device has the functions of prompting the circulation of blood and enforcing the backbone to be straight. Meanwhile, by the adjusting the tilting of the sole, the kidney and pelvis is active.

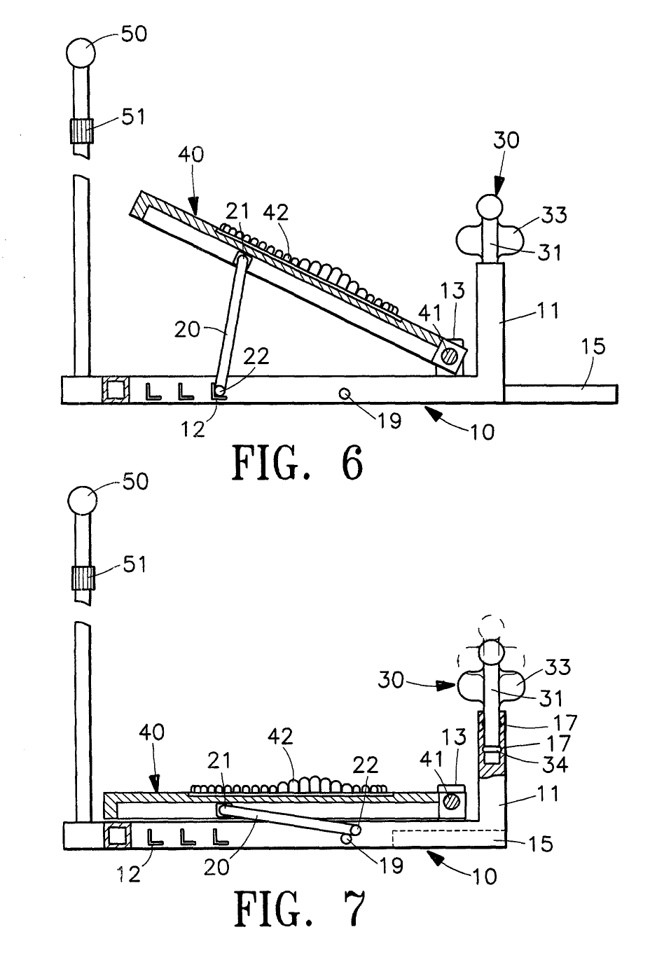

The distal end of the seat 10 is further extended with a telescopic safe board 15 for suppressing the seat 10 to move backwards, which has the function of increasing the area of the bottom as the tilt type jin-luo massaging device is placed on the ground, so as to prevent the user tilt thereon from falling down. As, the telescopic safe board 15 is not used, as shown in FIG. 7, it can be pushed or pivotally moved back to the seat 10 for reducing the storing space of the tilt type jin-luo massaging device.

The top of the pedal 40 is installed with two recesses 44 having a shape of the foot soles. The recesses 40 may be provided with two massaging pads 42. Each pad 42 has a plurality of particles 43 with different sizes so that as the user stands thereon, the pad 42 provides massaging effect to the user so as to prompt the circulation of blood.

A top of the seat 10 is installed with an inserting hole 18 for being inserted by a handle 50. The height of the handle 18 is adjustable. When the user is pushed by an applied external force or is not habitual to the tilt pose, or is unsteady due to other factors, the user may hold the handle 50 temporarily. The handle 50 has a height adjustable bottom 51. Thereby, the handle 50 is adjustable for suiting the requirement of the user.

The stopper 11 of the seat 10 is further installed with two inserting holes 61 for being inserted by a resisting massager 30. The resisting massager 30 has an approximate H shape and is a formable body with elasticity, which has a function identical to that of the stopper 11 for further stopping the rear ankle 62 so that the user will not slide out of the pedals 40 and to induce the user to stand straight. Besides, a transverse rod 32 of the resisting massager 30 is formed with a vibration massaging element 33 having a power source from a battery (not shown) in the rod 32 and having a control element of a switch (not shown) in the rod 32. Thereby, the user may select to switch the vibrating massaging element 33 so as to provide a vibrating massaging effect to the ankle 62 of the user. The height of the resisting massager 30 is adjustable to be matched to the height of the user. In a preferred embodiment, the inserting holes 16 at two sides have formed with a plurality of positioning grooves 17 at the inner walls. The straight rods 31 at two sides of the resisting massager 30 are installed with a positioning flange 34, respectively. By the engagement of the flange 34 with a selected the grooves 17, the protruding height of the resisting massager 30 resisting on the stopper 11 is adjustable.

Referring to FIG. 7, when the tilt type jin-luo massaging device is not used, the supporting frame 20 may pivotally rotate to be in horizontal position, and the free end 22 thereof is placed on the top of the seat 10, or on the transversal rod 19 thereon so that the pedals 40 are horizontal adhered on the upper side of the seat 10 due to the supporting of the supporting frame 20 being lost. Furthermore, a prior art buckle is used to detachably buckle the pedals 40 to the seat 10. While the telescopic safe board 15 is pushed back or pivotally rotated into the seat 10. Furthermore, the resisting massager 30 and the handle 50 are detached easily for reducing the storing space of the tilt type jin-luo massaging device.

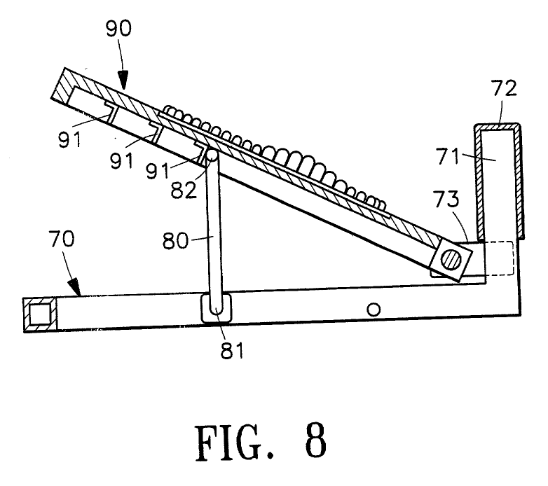

With reference to FIG. 8, another embodiment about the tilt type jin-luo massaging device of the present invention is illustrated. In this embodiment, the telescopic safe board 15, resisting massager 30, the handle 50 and other unnecessary elements are neglected for facilitating the structure of the tilt type jin-luo massaging device. The supporting frame 80 for supporting the pedals 40 is modified so that the openings at two sides are pivotally connected to the seat 70. The free end 82 is selectable to be inserted into the plurality of parallel positioning portions on the bottom of the pedals 80. By the tilt supporting frame 80, the pedals 90 is elevated with a higher front side and a lower rear side. The pivotal ears 73 at the upper side of the seat 70 for being pivotally connected to the pedals 90 are selectable to be fixed to be near the lower end of the stopper 71. Besides, the stopper 71 may be further installed with a soft rubber cover 72 for preventing the user from being hurt due to friction as the rear ankles 62 place thereon.

Comparing with the prior art, the tilt type jin-luo massaging device of the present invention has the following advantages:

1) The user can stand on the tilt type jin-luo massaging device with the foot points height than the heels and the rear ankles of the user resists against the stopper so that as the calf stands still, the feet of the user will feel the muscle to be pulled. Therefore, the device has the function of prompting the circulation of blood and enforcing the backbone to be straight. Meanwhile, by the adjusting the tilting of the sole, the kidney and pelvis are active;

2) The present invention provides a vibrating massaging effect to the ankle of the user so as to prompt the circulation of blood and reduce the ache of the foot from exercising; and

3) The tilt type jin-luo massaging device of the present invention has a simple structure and a compact volume and weight. The present invention only occupies a smaller space so that it can be stored in a smaller space and is portable without being confined as it is carried out.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A tilt type jin-luo massaging device comprising:
a seat having a distal end bending upwards so as to be formed with a rear stopper;
a pair of pedals at an upper side of the seat and each having a pivotal end pivotally connected to the seat near the rear stopper; each pedal further having a free end pivotally rotated with respect to the seat; and
a supporting frame for elevating the free end of the pedal so that the pedals are positioned and therefore, each free end is higher than a tilt position of the pivotal end.

2. The tilt type jin-luo massaging device as claimed in claim 1, wherein a plurality of parallel positioning portions are installed on the seat, and one end of the supporting frame is pivotally to the pedal, another end of the supporting frame is selectable to be inserted into one of the positioning portions.

3. The tilt type jin-luo massaging device as claimed in claim 1, wherein the a plurality of parallel positioning portions are installed on the pedal, and one end of the supporting frame is pivotally to the seat, another end of the supporting frame is selectable to be inserted into one of the positioning portions.

4. The tilt type jin-luo massaging device as claimed in claim 1, wherein a telescopic safe board further extends backwards from a distal end of the seat.

5. The tilt type jin-luo massaging device as claimed in claim 1, wherein the two massaging pads are formed at two pedals of the tilt type jin-luo massaging device, thereby the user can stand thereon.

6. The tilt type jin-luo massaging device as claimed in claim 1, wherein a height adjustable handle is installed into the seat.

7. The tilt type jin-luo massaging device as claimed in claim 1, wherein an upper side of the stopper is inserted by a resisting massager the height of which is adjustable, and at least one vibrating massaging element is installed on the resisting massager.

8. The tilt type jin-luo massaging device as claimed in claim 1, wherein a soft rubber cover covers on the rear stopper of the tilt type jin-luo massaging device.
